(19) United States
(12) Patent Application Publication
(10) Pub. No.: US 2019/0065168 A1
(43) Pub. Date: Feb. 28, 2019

(54) APPARATUS AND METHOD TO SHORTEN SOFTWARE INSTALLATION TIME BASED ON A HISTORY OF FILE INSTALLATION

(71) Applicant: FUJITSU LIMITED, Kawasaki-shi (JP)

(72) Inventors: Katsuaki Nakamura, Kawasaki (JP); Hiroshi Iyobe, Yokohama (JP); KOJI HASHIMOTO, Kawasaki (JP); Hiroshi Nakanishi, Osaka (JP)

(73) Assignee: FUJITSU LIMITED, Kawasaki-shi (JP)

(21) Appl. No.: 16/106,779

(22) Filed: Aug. 21, 2018

(30) Foreign Application Priority Data
Aug. 25, 2017 (JP) 2017-161988

(51) Int. Cl. G06F 8/61; G06F 8/65

(52) U.S. Cl. CPC G06F 8/61; G06F 8/65

(57) ABSTRACT

An apparatus acquires information identifying first-pieces of software that are candidates for installation, and estimates first files to be installed at a time of installation of the first-pieces of software with reference to file-identification information identifying second files that have been installed at a time of installation of second-pieces of software, where the file-identification information is associated with respective ones of the second-pieces of software, and the first files are estimated based on the file-identification information identifying third files that have been installed in connection with third pieces of software related to the first-pieces of software. The apparatus identifies, from among the first-pieces of software, fourth-pieces of software which include the estimated first files and which have less overlapping of installation of an identical file than a case of installing all the first-pieces of software, and executes installation of the fourth-pieces of software.

### CROSS-REFERENCE TO RELATED APPLICATION

This application is based upon and claims the benefit of priority of the prior Japanese Patent Application No. 2017-161988, filed on Aug. 25, 2017, the entire contents of which are incorporated herein by reference.

### FIELD

The embodiments discussed herein are related to apparatus and method to shorten software installation time based on a history of file installation.

### BACKGROUND

Software running on a computer may be corrected using software for correction. Software for correction is released as, for example, a patch file by a developer or distributor of software.

Data and programs used for software correction are included in the patch file. For example, when there is a bug (defect in a program) in software, by performing a process of installing patch file, a defective program file is updated to a program file of which the defect is corrected. The patch file is sometimes simply called “patch”. Also, a process of installing patches and correcting program defects is also called application of patches to software, distinguished from general software installation.

Application of a patch to software executed on a computer is executed with work using that software stopped. For that reason, in many cases, patches are applied for avoiding business hours. For example, when the computer is shut down, a patch for software in the computer is applied.

As a technique relating to patch application, for example, there is a preventive maintenance device that provides patch information in accordance with an operating environment of a customer system and further provides a time zone for which the patch is to be applied so as to reduce a burden on a customer. There is also an application patch selection apparatus which enables a user to easily and automatically select only patches which the user wishes to apply from among a large number of patches applicable to the system. Further, there is also a patch application system which flexibly changes an application method and the application time of patches according to a situation of a machine and also automatically applies patches such as an interactive type patch.

Japanese Laid-open Patent Publication No. 2010-128581, International Publication Pamphlet No. WO2007/105274, Japanese Laid-open Patent Publication No. 2010-250749, and the like are examples of the related art.

### SUMMARY

According to an aspect of the invention, an apparatus acquires first software-identification information identifying respective ones of first pieces of software that are candidates for installation, and estimates first files to be installed at a first time at which the first pieces of software are expected to be installed, with reference to a memory storing file-identification information identifying second files that have been installed at a second time at which second pieces of software have been installed, wherein the first file-identification information is stored in association with second software-identification information identifying respective ones of the second pieces of software, and the first files are estimated based on the file-identification information identifying third files among the second files, the third files being installed in connection with third pieces of software related to the first pieces of software among the second pieces of software. The apparatus identifies, from among the first pieces of software, one or more fourth pieces of software which include the estimated first files and which have less overlapping of installation of an identical file than a case of installing all the first pieces of software, and executes installation of the one or more fourth pieces of software.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration example of an information processing apparatus according to a first embodiment;

FIG. 2 is a diagram illustrating a configuration example of a system of a second embodiment;

FIG. 3 is a diagram illustrating a configuration example of hardware of a terminal device;

FIG. 4 is a block diagram illustrating an example of a function of each device of the second embodiment;

FIG. 5 is a table illustrating an example of a software dictionary;

FIG. 6 is a table illustrating an example of a patch configuration file list;

FIG. 7 is a table illustrating an example of a similar patch configuration file list;

FIG. 8 is a table illustrating an example of an application candidate patch configuration file list;

FIG. 9 is a table illustrating an example of a file usage status list;

FIG. 10 is a table illustrating an example of a new-patch application result list;

FIG. 11 is a table illustrating an example of a newly-released-patch application management table;

FIG. 12 is a sequence diagram illustrating a procedure of first stage patch application processing;

FIG. 13 is a first half of a flowchart illustrating an example of a procedure of application patch determination processing;

FIG. 14 is a diagram illustrating an example of determination of an application patch by a first application patch determination method;

FIG. 15 is a second half of the flowchart illustrating the example of the procedure of the application patch determination process;

FIG. 16 is a diagram illustrating an example of determination of an application patch by a second application patch determination method;

FIG. 17 is a flowchart illustrating an example of a procedure of similar patch configuration file list generation processing;

FIG. 18 is a flowchart illustrating an example of a procedure of application candidate patch configuration file list generation processing;

FIG. 19 is a sequence diagram illustrating a procedure of second stage patch application processing;

FIG. 20 is a flowchart illustrating an example of procedure of additional application patch determination processing; and

FIG. 21 is a diagram illustrating an example of determination of an additional application patch.

### DESCRIPTION OF EMBODIMENTS

Software bugs include, for example, security defects (security holes). In order to safely operate a computer, it is appropriate to apply a patch (security patch) that corrects security defects as soon as possible after release of the patch. That is, even during work, it is desirable for important patches such as security patches to be applied immediately by stopping the work. On the other hand, in recent years, the number of patches having high importance, such as security patches, released is increased and the size of one patch is becoming larger. For that reason, it may take hours to apply all patches having high importance. When application of such a patch is executed by stopping the work, a stop period of work due to application of the patches is prolonged and huge hindrance to performance of work is caused.

Although description is made by focusing on application of the patch, when software is installed on a computer, not limited to patches, use of related running software may be stopped. If there are a plurality of pieces of software to install, the installation time is prolonged, and the stop period of work is also prolonged.

As one aspect of the embodiment, provided are solutions for being able to shorten the software installation time.

Hereinafter, embodiments will be described with reference to the drawings. Each embodiment may be implemented by combining a plurality of embodiments in a range without contradiction.

### First Embodiment

First, a first embodiment will be described.

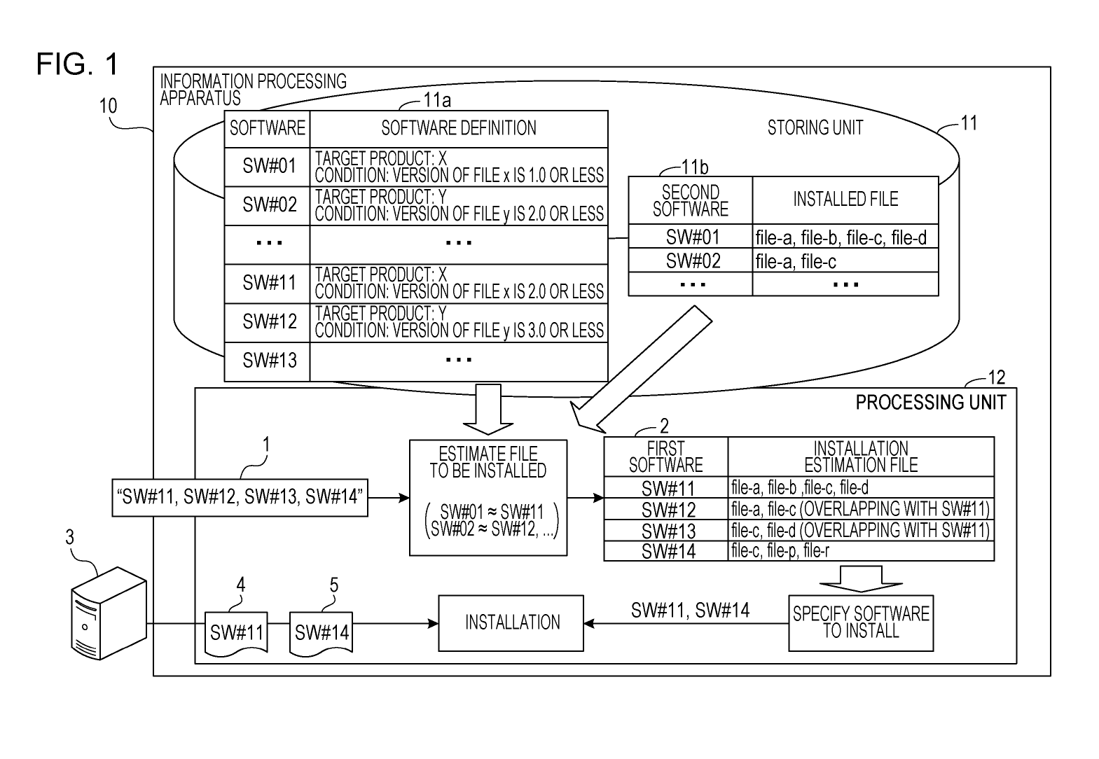

FIG. 1 is a diagram illustrating a functional configuration example of an information processing apparatus according to the first embodiment. An information processing apparatus 10 includes a storing unit 11 and a processing unit 12. The storing unit 11 is, for example, a memory or a storage device included in the information processing apparatus 10. The processing unit 12 is, for example, a processor or an operation circuit included in the information processing apparatus 10.

The storing unit 11 stores, for example, software definition information 11a and installation file information 11b.

In the software definition information 11a, information indicating the characteristics of software is set in association with identification information of the software. For example, when the software is a corrected version or an improved version of another piece of software, a product name of the other software to be corrected or improved is set in software definition as the characteristics of software. Also, a file name of a file used for determining the necessity of software installation is set in the software definition.

In the installation file information 11b, identification information of the file installed at the time of installation of each of a plurality of pieces of second software having actual installation results are set in association with identification information of each of the plurality of pieces of second software.

The processing unit 12 efficiently executes software installation processing by referring to information stored in the storing unit 11. For example, the processing unit 12 acquires installation candidate software information 1 including pieces of identification information of a plurality of pieces of first software that are installation candidates. The installation candidate software information 1 is input from, for example, a server 3 coupled to the information processing apparatus 10 via a network.

When the installation candidate software information 1 is acquired, the processing unit 12 refers to the storing unit 11 and estimates a file to be installed at the time of installation of the first software for each of the plurality of pieces of first software. The processing unit 12 generates installation estimation file information 2 including a result estimated for each of the plurality of pieces of first software.

This estimation processing is performed based on identification information of the file installed at the time of installation of second software related to the first software. The second software related to the first software may be determined, for example, based on the software definition information 11a. For example, the processing unit 12 refers to the software definition information 11a and determines one or a plurality of pieces of second software having characteristics similar to those of the first software among the plurality of pieces of second software as the second software related to the first software. In the example of FIG. 1, the processing unit 12 retrieves, among a plurality of pieces of second software, one or the plurality of pieces of second software, which has a corresponding software product name and a file name to be used for determining the necessity of installation common to those of the first software, from the software definition information 11a. Then, the processing unit 12 determines the second software determined as corresponding software by the retrieval as the second software related to the first software.

Next, the processing unit 12 specifies one or plurality of pieces of software which includes the plurality of estimated files and has less overlapping of installation of the same file than a case of installing the plurality of pieces of first software, among the plurality of installation candidate first software. For example, the processing unit 12 determines the presence or absence of overlapping of files estimated for each of the plurality of pieces of first software, based on the installation estimation file information 2. When there is overlapping among the files estimated for each of the plurality of pieces of first software, the processing unit 12 specifies one or a plurality of pieces of installation target first software that is a portion of the plurality of pieces of first software satisfying a predetermined condition. The predetermined condition is a condition that a first set including the files estimated for respective ones of the one or plurality of installation target first software is equal to a second set including the files estimated for respective ones of the plurality of pieces of first software.

The processing unit 12 executes installation of the one or plurality of specified installation target first software. For example, the processing unit 12 acquires installation files 4 and 5 corresponding to the one or plurality of installation target first software, respectively, from a server 3. Then, the processing unit 12 executes installation processing of the one or plurality of installation target first software using the installation files 4 and 5.

According to such an information processing apparatus 10, installation processing is omitted for a piece of first software of which the installed file overlaps that of another piece of first software. As a result, the total number of pieces of software to be installed is reduced, and the installation time is shortened.

In the example of FIG. 1, “SW#11, SW#12, SW#13, and SW#14” are set, as identification information of a plurality of pieces of first software, in the installation candidate software information 1. When referring to the software definition information 11a, a product name to be targeted and a file used for determining an installation condition of first software of identification information “SW#11” are the same as those of second software of identification information “SW#01”. Accordingly, the first software of identification information “SW#11” is associated with the second software of identification information “SW#01”. When referring to the installation file information 11b, it is understood that the “file-a, file-b, file-c, and file-d” were installed at the time of installation of the second software of identification information “SW#01”. Therefore, it is estimated that the “file-a, file-b, file-c, and file-d” are installed even when the first software of identification information “SW#11” is installed. Similarly, for other pieces of first software (having identification information of “SW#12, SW#13, and SW#14”), the file to be installed is estimated. From the estimation result, installation estimation file information 2 is generated.

When referring to the installation estimation file information 2, the files estimated for the first software of identification information “SW#12” are the “file-a and file-c”. These files overlap the files estimated for the first software of identification information “SW#11”. That is, if the first software of identification information “SW#11” is installed even without installing the first software of identification information “SW#12”, the files estimated for the first software of identification information “SW#12” are installed. Accordingly, it may be seen that installation of the first software of identification information “SW#12” may be omitted.

Similarly, the files estimated for first software of an identification information “SW#13” are the “file-c and file-d”, and these files overlap the files estimated for the first software of identification information “SW#11”. Accordingly, installation of the first software of identification information “SW#12” may be omitted.

The files estimated for first software of identification information “SW#14” are the “file-c, file-p, and file-r”. Among these files, the “file-p and file-r” are not included in the files estimated for the first software of identification information “SW#11”. Accordingly, installation of the first software of identification information “SW#14” may not be omitted.

As such, installation of some of the plurality of pieces of first software may be omitted. One or a plurality of pieces of first software of which installation may not be omitted becomes installation target first software. Finally, a first set including the files estimated for respective pieces of the installation target first software is equal to a second set including the files estimated for respective ones of the plurality of pieces of first software, and the smallest installation target first software is determined. In the example of FIG. 1, the pieces of first software of pieces of identification information “SW#11” and “SW#14” are the installation target first software.

Then, installation files 4 and 5 that respectively correspond to the pieces of first software of pieces of identification information “SW#11” and “SW#14” are acquired from the server 3, and these pieces of first software are installed in the information processing apparatus 10. As such, in the example of FIG. 1, although identification information of four pieces of first software are indicated in the installation candidate software information 1, only two pieces of software may be installed. If the installation time of each of the four pieces of first software is about the same, the installation time is halved compared with a case of installing four pieces of first software. Accordingly, the installation time is shortened.

In estimating the files to be installed, a plurality of pieces of second software related to the first software may be present. In this case, the processing unit 12 estimates, for example, a common installation file commonly installed in each piece of the related second software as a file to be installed at the time of installation of the first software. With this, it is possible to estimate the file that is supposed to be installed reliably.

In estimating the files to be installed, in a case where a plurality of pieces of second software related to the first software are present, there may also be files installed only with some of pieces of related second software. Such a file may be installed even when the first software is installed. In the first software, in a case where such a file having a possibility of being installed is present, the processing unit 12 determines whether or not to install the first software, according to a usage status of the file. In this case, the storing unit 11 stores a plurality of files and file usage information indicating the presence or absence of usage of a plurality of files within a corresponding operation period for each category related to an operation period of a computer in advance. The processing unit 12 refers to the storing unit 11 and determines the file having a possibility of being installed based on identification information of the files installed at the time of installation of the second software related to the first software, for each of the plurality of pieces of first software. The processing unit 12 refers to the file usage information and determines whether the file having a possibility of being installed at the time of installation of the first software is used within the operation period in accordance with the current date and time. In a case where the file having a possibility of being installed at the time of installation of the first software is used within the operation period, the processing unit 12 includes the first software in the one or plurality of installation target first software.

With this, the first software with which a file to be used soon may be installed is installed immediately. In contrast, the first software with a file having a possibility of being installed is not used immediately is excluded from installation targets. As a result, it is possible to exclude the first software which may not be installed in a hurry from installation targets, and the installation time may be shortened.

In the example described above, software to be installed is determined based on the estimation result of the file installed at the time of installation of the first software, but the estimation result may be erroneous in some cases. Accordingly, in a case where an error is found in the estimation result after the file is actually installed in the first software, the processing unit 12 may determine first software to be additionally installed based on the actually installed file.

For example, the processing unit 12 acquires identification information of a file installed at the time of installation of each of the plurality of pieces of first software, based on actual installation results of each of the plurality of pieces of first software, after installation of the specified installation target first software. The processing unit 12 confirms the presence or absence of an uninstalled file that is not installed at the time of installation of the installation target first software, among the files installed at the time of installation of each of the plurality of pieces of first software. In a case where the uninstalled file is present, the processing unit 12 specifies uninstallation first software that installs the uninstalled file during the installation thereof, among the plurality of pieces of first software, as an additional installation target. Then, the processing unit 12 executes installation of the uninstallation first software to be additionally installed.

With this, even if there is an error in the estimation result of the installed file, it is possible to avoid the first software to be installed from leaking from the installation targets. Software designated as the installation candidate is, for example, a patch of software already installed in the information processing apparatus 10. If a patch is applied in processing indicated in the first embodiment, it is possible to shorten the time taken for applying the patch in a case where a large number of patches are simultaneously released. That is, the stop period of work using software of a patch application destination may be shortened.

Software designated as the installation candidate may be, for example, software of the next version of software already installed in the information processing apparatus 10. Even in a case of updating the version, work using old version software is stopped. In the case of a plurality of pieces of highly related software, pieces of software of these updated versions may be distributed at the same time. Also, in such a case, the installation time of software of the updated version may be shortened by the processing described in the first embodiment.

### Second Embodiment

Next, a second embodiment will be described. The second embodiment is a system that shortens the application time of a patch such as a security patch.

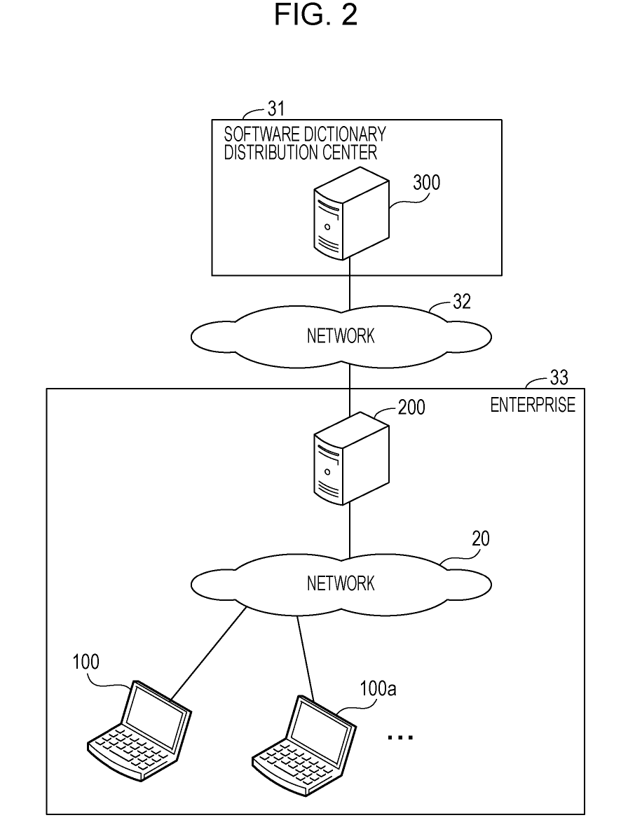

FIG. 2 is a diagram illustrating a configuration example of a system of the second embodiment. A software dictionary distribution server 300 of a software dictionary distribution center 31 and a management server 200 in an enterprise 33 are coupled via a network 32. The software dictionary distribution server 300 is a computer that provides information on software used by the enterprise 33. The management server 200 is a computer that manages software used by computers in the enterprise 33.

The management server 200 is coupled to a plurality of terminal devices 100, 100a, . . . via a network 20 in the enterprise. The terminal devices 100, 100a, . . . are computers that execute work using various software.

In such a system, a patch of software installed in the terminal device 100, 100a, . . . may be distributed from a vendor of the software. The patch of software is input to the management server 200 by a person in charge of system management of the enterprise 33. Under control of the management server 200, the patch is applied to the terminal devices 100, 100a, . . . .

Each of the terminal devices 100, 100a, . . . acquires a patch file (file including a program and data for software correction) via the management server 200, and applies the patch to installed software. In this case, each of the terminal devices 100, 100a, . . . excludes the patch file that satisfies a predetermined condition, among a plurality of patch files, from an application target. For example, in a case where all files to be updated by applying the patch are updated by application of another patch, there is no reason for updating the files by being overlapped, so that each of the terminal devices 100, 100a, . . . excludes the patch from the application targets. As such, each of the terminal devices 100, 100a, . . . excludes patches that may not be applied at least immediately from application targets so as to shorten the application time of patches.

An application patch determination method for shortening the application time of the patch includes the following three methods.

[First Application Patch Determination Method]

Each of the plurality of terminal devices 100, 100a, . . . estimates a configuration file of a newly released patch. Then, each of the plurality of terminal devices 100, 100a, . . . applies the minimum patch including all configuration files of the patch in which an application target software is installed to the terminal device itself. With this, the number of patches to be applied may be reduced.

[Second Application Patch Determination Method]

Each of the plurality of terminal devices 100, 100a, . . . collects a file usage history. Although each of the plurality of terminal devices 100, 100a, . . . may not determine that the collected file is a configuration file of a newly released patch, for a file that may be the configuration file, each of the plurality of terminal devices 100, 100a, . . . determines the presence or absence of application of a patch including the file, according to the usage status. For example, each of the plurality of terminal devices 100, 100a, . . . does not apply a patch including a file not used in the configuration file, or applies the patch later (for example, at the time of shutdown).

[Third Application Patch Determination Method]

In the case where application omission occurs in patch application by the first and second application patch determination methods after actually applying the patch, each of the plurality of terminal devices 100, 100a, . . . specifies the patch of which application is omitted by the result of actually applying the security patch. Then, each of the plurality of terminal devices 100, 100a, . . . additionally applies the patch of which application is omitted.

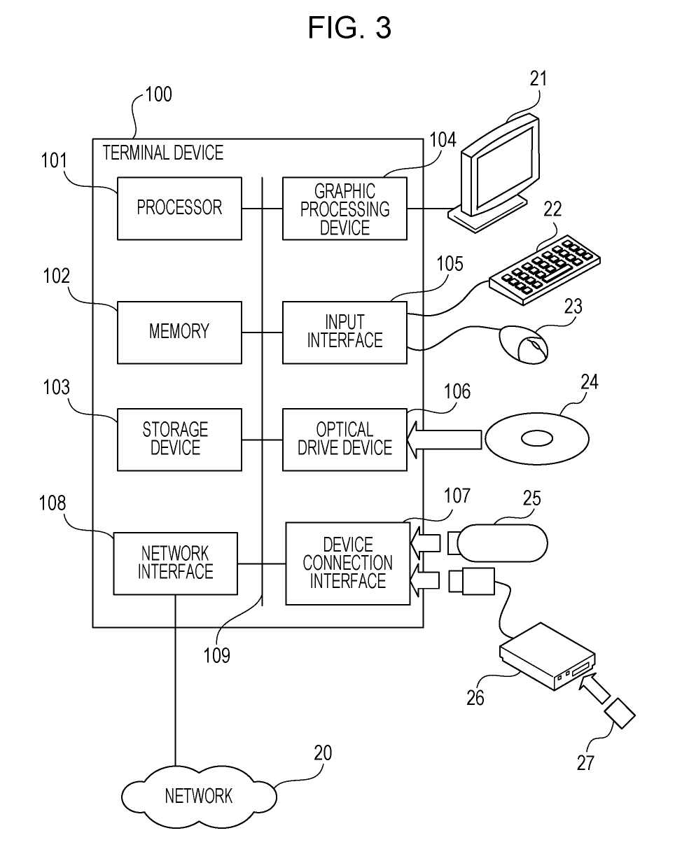

FIG. 3 is a diagram illustrating a configuration example of hardware of a terminal device. The terminal device 100 is controlled in its entirety by a processor 101. A memory 102 and a plurality of peripheral devices are coupled to the processor 101 via a bus 109. The processor 101 may be a multiprocessor. The processor 101 is, for example, a central processing unit (CPU), a micro processing unit (MPU), or a digital signal processor (DSP). At least a portion of functions realized by executing a program by the processor 101 may be realized by electronic circuits such as an application specific integrated circuit (ASIC) and a programmable logic device (PLD).

The memory 102 is used as a main storage device of the terminal device 100. In the memory 102, at least a portion of an application program and an operating system (OS) program to be executed by the processor 101 is temporarily stored. In the memory 102, various data used for processing by the processor 101 is stored. As the memory 102, for example, a volatile semiconductor memory device such as a random access memory (RAM) is used.

The peripheral devices coupled to the bus 109 include a storage device 103, a graphic processing device 104, an input interface 105, an optical drive device 106, a device connection interface 107, and a network interface 108.

In the storage device 103, data is electrically or magnetically read and write from and into to a recording medium a built in the storage device 103. The storage device 103 is used as an auxiliary storage device of a computer. In the storage device 103, programs of the OS, the application program, and various data are stored. As the storage device 103, for example, a hard disk drive (HDD) or a solid state drive (SSD) may be used.

A monitor 21 is coupled to the graphic processing device 104. The graphic processing device 104 displays an image on a screen of the monitor 21 according to an instruction from the processor 101. As the monitor 21, a display device using a cathode ray tube (CRT), a liquid crystal display device, and the like are included.

A keyboard 22 and a mouse 23 are coupled to the input interface 105. The input interface 105 transmits signals sent from the keyboard 22 and the mouse 23 to the processor 101. The mouse 23 is an example of a pointing device, and other pointing devices can also be used. Other pointing devices include a touch panel, a tablet, a touch pad, a track ball, and the like.

The optical drive device 106 reads data recorded on an optical disk 24 using laser light or the like. The optical disk 24 is a portable recording medium on which data is recorded so as to be readable by reflection of light. As the optical disk 24, a digital versatile disk (DVD), DVD-RAM, a compact disk read only memory (CD-ROM), a CD-recordable/rewritable (CD-R/RW), and the like are included.

The device connection interface 107 is a communication interface for coupling the peripheral devices to the terminal device 100. For example, a memory device 25 and a memory reader/writer 26 may be coupled to the device connection interface 107. The memory device 25 is a recording medium having a communication function with the device connection interface 107. The memory reader/writer 26 is a device that writes data into a memory card 27 or reads data from the memory card 27. The memory card 27 is a card type recording medium.

A network interface 108 is coupled to the network 20. The network interface 108 transmits and receives data to and from another computer or a communication device via the network 20.

With hardware configuration as described above, the processing function of the terminal device 100 of the second embodiment may be realized. The other terminal devices 100a, . . . the management server 200 and the software dictionary distribution server 300 illustrated in FIG. 2 may also be realized by the same hardware as that of the terminal device 100. Further, the information processing apparatus 10 described in the first embodiment may also be realized by the same hardware as that of the terminal device 100 illustrated in FIG. 3.

The terminal device 100 realizes the processing function of the second embodiment by executing a program recorded on a computer readable recording medium, for example. A program in which processing contents to be executed by the terminal device 100 are described may be recorded in various recording media. For example, the program to be executed by the terminal device 100 may be stored in the storage device 103. The processor 101 loads at least a portion of a program in the storage device 103 into the memory 102 and executes the program. The program to be executed by the terminal device 100 may be recorded in a portable recording medium such as the optical disk 24, the memory device 25, the memory card 27 or the like. The program stored in the portable recording medium may be executed after being installed in the storage device 103, for example, under control of the processor 101. The processor 101 can read and execute the program directly from the portable recording medium.

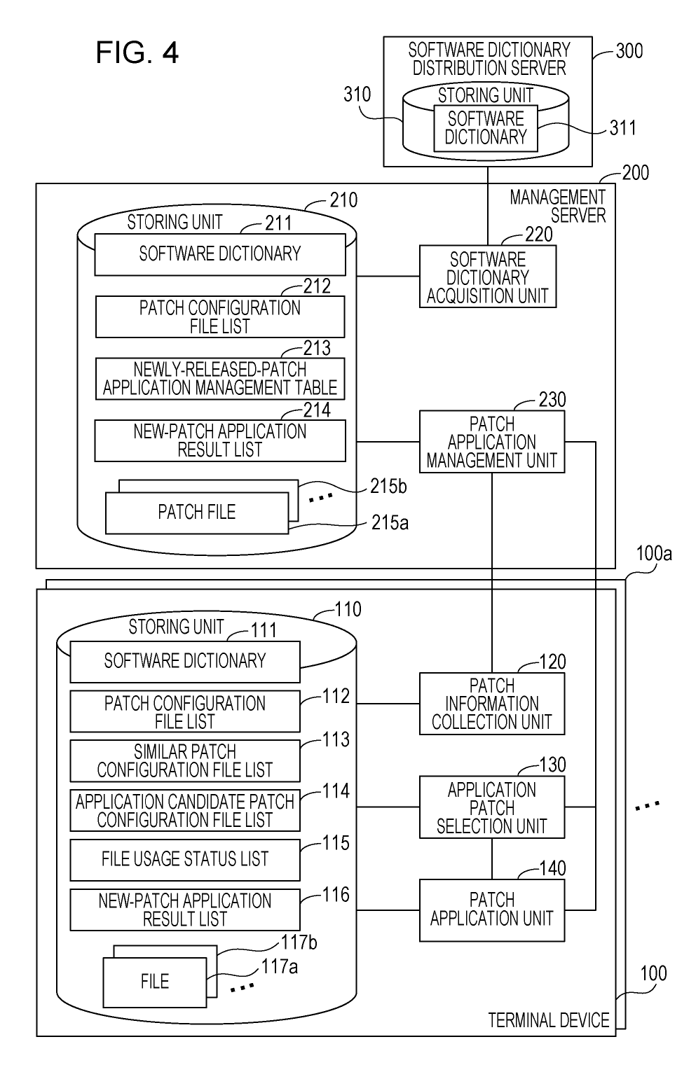

FIG. 4 is a block diagram illustrating an example of functions of respective devices of the second embodiment. The software dictionary distribution server 300 includes a storing unit 310 for storing a software dictionary 311. The storing unit 310 is, for example, a memory or a storage device included in the software dictionary distribution server 300. The software dictionary 311 is a database in which various pieces of information on each of a plurality of software are recorded.

The management server 200 includes a storing unit 210, a software dictionary acquisition unit 220, and a patch application management unit 230. The storing unit 210 is, for example, a memory or a storage device included in the management server 200. The software dictionary acquisition unit 220 and the patch application management unit 230 are functions executed by, for example, a processor included in the management server 200.

The storing unit 210 stores a software dictionary 211, a patch configuration file list 212, a newly-released-patch application management table 213, a new-patch application result list 214, and a plurality of patch files 215a, 215b, . . . . The software dictionary 211 is a database having the same contents as the software dictionary 311 of the software dictionary distribution server 300. The patch configuration file list 212 is a list of files installed when the patches applied to any one of the plurality of terminal devices 100, 100a, . . . are applied. The newly-released-patch application management table 213 is a data table for managing the terminal device to which a newly distributed patch (newly released patch) is applied. The new-patch application result list 214 is a list of files installed when a newly released patch is applied to any one of the plurality of terminal devices 100, 100a, . . . . Each of a plurality of patch files 215a, 215b, . . . is a file including a patch program and data.

The software dictionary acquisition unit 220 acquires the software dictionary 311 from the software dictionary distribution server 300 and stores the software dictionary 311 in the storing unit 210 as an internal software dictionary 211.

The patch application management unit 230 instructs application of the newly released patch to each of the plurality of terminal devices 100, 100a, . . . . The patch application management unit 230 transmits information, which is used for applying the newly released patch by each of the plurality of terminal devices 100, 100a, . . . , to each of the plurality of terminal devices 100, 100a, . . . . Furthermore, the patch application management unit 230 collects information on application results of application patches from each of the plurality of terminal devices 100, 100a, . . . , and notifies the application result of the patch to each of the plurality of terminal devices 100, 100a, . . . .

The terminal device 100 includes a storing unit 110, a patch information collection unit 120, an application patch selection unit 130, and a patch application unit 140. The storing unit 110 is, for example, the memory 102 or the storage device 103 included in the terminal device 100. The patch information collection unit 120, the application patch selection unit 130, and the patch application unit 140 are, for example, functions executed by the processor 101 included in the terminal device 100.

The storing unit 110 stores a software dictionary 111, a patch configuration file list 112, a similar patch configuration file list 113, an application candidate patch configuration file list 114, a file usage status list 115, a new-patch application result list 116, and a plurality of files 117a, 117b, . . . other than the lists. The software dictionary 111 is a database having the same contents as the software dictionary 111 included in the software dictionary distribution server 300. The patch configuration file list 112 is a data table having the same contents as the patch configuration file list 112 included in the management server 200. The similar patch configuration file list 113 is a data table that indicates information of files installed at the time of applying the patch that belongs to a patch group obtained by grouping patches in a similar relationship. The application candidate patch configuration file list 114 is a list of files expected to be installed by applying the newly released patch. The file usage status list 115 is a data table indicating the usage status of each of the plurality of files 117a, 117b, . . . in the terminal device 100. Similar to the new-patch application result list 214 stored in the management server 200, the new-patch application result list 116 is a list of files installed when a newly released patch is applied to any one of the plurality of terminal devices 100, 100a, . . . . Unlike the new-patch application result list 214 stored in the management server 200, the new-patch application result list 116 includes information on whether the newly released patch is applied to the terminal device 100 itself or another terminal device 100a. The plurality of files 117a, 117b, . . . are files used by software installed in the storing unit 110. In a case where a patch is applied to software, for example, a new file for that software is installed. Also, due to application of patches to software, the file used by software may be replaced with a file of a new version of the same name.

The line connecting the elements illustrated in FIG. 4 indicates a portion of a communication path, and a communication path other than the illustrated communication path may also be set. The function of each element illustrated in FIG. 4 may be realized, for example, by causing a computer to execute a program module corresponding to the element.

Next, information stored in the storing unit of each device will be described in detail. In the following description, first, information stored in the storing unit 110 of the terminal device 100 will be described in detail, and thereafter, among information stored in the storing unit 210 of the management server 200, information that is not stored in the storing unit 110 of the terminal device 100 will be described.

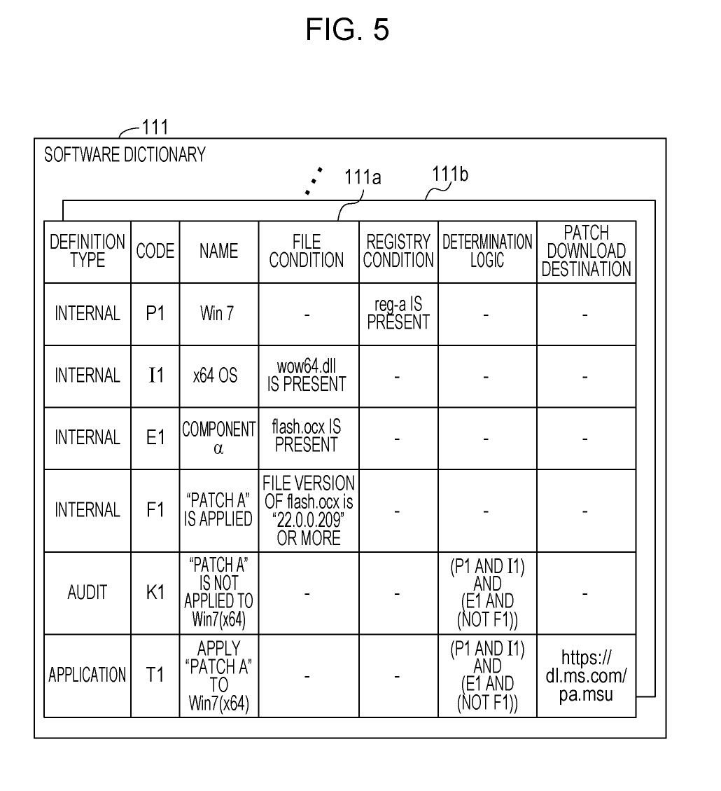

FIG. 5 is a table illustrating an example of a software dictionary. In the software dictionary 111, software definition information 111a, 111b, . . . generated for each software are included. One or more pieces of software definition information are generated for one piece of software. For example, for software including components corresponding to each of a number of functions, software definition information may be generated for each component.

In each of a plurality of pieces of software definition information 111a, 111b, . . . included in the software dictionary 111, fields for a definition type, code, name, file condition, registry condition, determination logic, and patch download destination are provided.

In the field of the definition type, a type (definition type) of information defined in a registered record is set. As the definition type, internal, audit, application, and the like are included. The definition type of “internal” is definition for a software product, components constituting software, files included in software, and the like. The definition type of “audit” is definition concerning determination logic as to whether or not a patch is applied based on the definition of “internal”. The definition type of “application” is definition concerning information to be used when a patch determined not to be applied is applied, based on the definition of “audit”.

In the field of the code, an identification code of definition for each record is set. In the field of the name, a name of definition is set. In the field of the file condition, a condition concerning the file to which definition is applied is set. In the field of the registry condition, a condition concerning a registry to which definition is applied is set. In the field of the determination logic, a logical expression for determining whether or not a patch is applied is set. In the field of the patch download destination, an access destination (storage location of the patch file) at the time of downloading the patch in the definition concerning application of the patch is set.

For example, in the software definition information 111a, definition information concerning application of a patch called “patch A” is set for a component called “component α” that operates in the 64-bit OS called “Win 7”. In the software definition information 111a, in a case where the version of a file “flash.ocx” is “22.0.0.209” or more, it is defined that “patch A” is applied to the corresponding component. That is, if the version of “flash.ocx” is less than “22.0.0.209”, the “patch A” is not applied.

Accordingly, in the definition type of “audit”, determination logic “(P1 AND I1) AND (E1 AND (NOT F1))” defining that the “patch A” is not applied is defined. In this determination logic, when both of a condition that definition “P1” and definition “I1” are satisfied and a condition that definition “E1” is satisfied but definition “F1” is not satisfied are established, it is defined that the “patch A” is not applied.

In the definition type of “application”, determination logic indicating a condition for applying the “patch A” and an access destination for downloading a patch are defined. In the example of the software definition information 111a, the determination logic of the definition type of “application” is the same as the determination logic of the definition type of “audit”.

Based on such software definition information, it is possible to determine whether or not to apply the patch to software in each of the plurality of terminal devices 100, 100a, . . . .

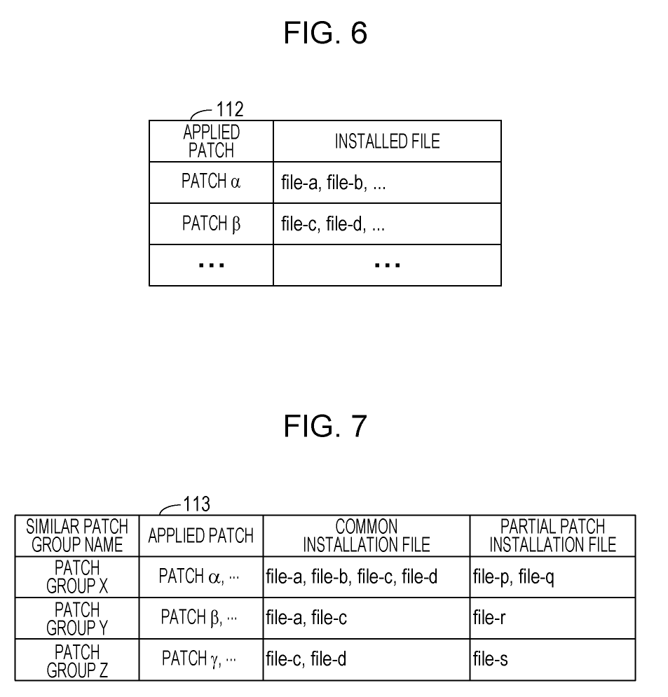

FIG. 6 is a table illustrating an example of a patch configuration file list. In the patch configuration file list 112, fields for an applied patch and an installed file are provided. In the field of the applied patch, a name of the patch applied to any one of the plurality of terminal devices 100, 100a, . . . is set. In the field of the installed file, a file name of a file installed at the time of application of the patch applied to any one of the plurality of terminal devices 100, 100a, . . . is set. The file name of the file installed at the time of application of the patch is acquired, for example, by hooking a file access event by a patch application process by the patch application unit 140.

FIG. 7 is a table illustrating an example of a similar patch configuration file list. In the similar patch configuration file list 113, fields for a similar patch group name, applied patch, common installation file, and partial patch installation file are provided. In the field of the similar patch group name, a name of a set of similar patches (similar patch group) is set. Whether the patches are similar or not is determined from the following conditions in the software dictionary, for example. •Application target products are the same. •Files to be referred to in order to determine whether the patch is not applied/is applied are the same.

A set of patches between which these two conditions are common are grouped in one similar patch group.

In the field of the applied patch, a name of the applied patch which belongs to the corresponding patch group and is applied to any one of the plurality of terminal devices 100, 100a, . . . is set. In the field of the common installation file, a file name of the file installed at the time of application in all the applied patches belonging to the patch group is set. In the field of the partial patch installation file, the file name of the file installed at the time of application in some applied patches belonging to the patch group is set.

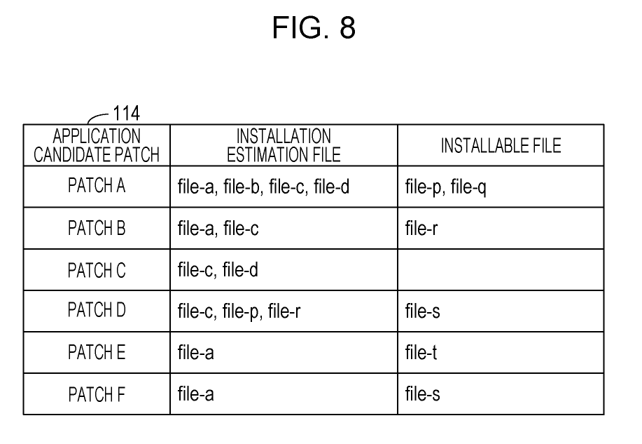

FIG. 8 is a table illustrating an example of an application candidate patch configuration file list. In the application candidate patch configuration file list 114, fields for an application candidate patch, installation estimation file, and file having a possibility of being installed are provided.

In the field of the application candidate patch, a name of a newly released patch (application candidate patch) of which application target software is installed in the terminal device 100 is set.

In the field of the installation estimation file, a file name of a file estimated to be installed by applying the application candidate patch is set. The file estimated to be installed is determined by the application patch selection unit 130, based on the similar patch configuration file list 113. For example, the application patch selection unit 130 determines the similar patch group to which the application candidate patch belongs, and sets the common installation file of the similar patch group as a file estimated to be installed.

In the field of the file having a possibility of being installed, a file name of a file having a possibility of being installed by applying the application candidate patch is set. The file having a possibility of being installed is determined by the application patch selection unit 130, based on the similar patch configuration file list 113. For example, the application patch selection unit 130 determines a similar patch group to which the application candidate patch belongs, and sets the file installed only when applying some of the applied patches belonging to the similar patch group as the file having a possibility of being installed.

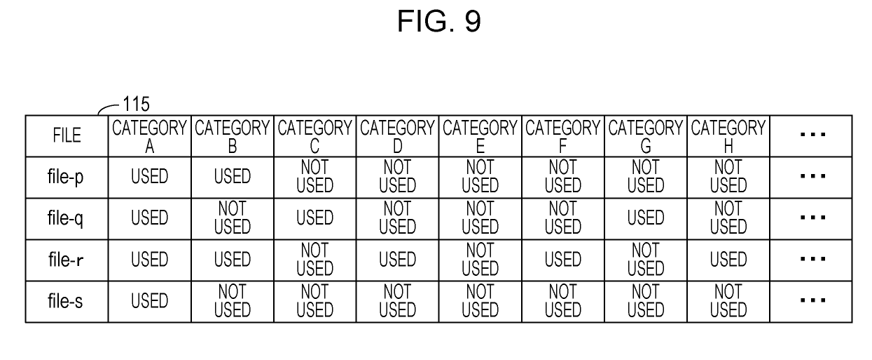

FIG. 9 is a table illustrating an example of a file usage status list. In the file usage status list 115, fields for a file and a plurality of category are provided. In the field of the file, a name of each of the plurality of files 117a, 117b, . . . in the terminal device 100 is set. In the field of the categories, for each category concerning the file usage status, a flag indicating whether or not a corresponding file is used in the category is set.

As the categories concerning the file usage status, for example, categories are set based on the following criteria: •Each day of a week; •holiday, one day before a holiday, one day after a holiday; •5th and 10th days of each month, one day before 5th and 10th days of each month, one day after 5th and 10th days of each month; and •1st day of each month, the end of a month, first business day of a month, and last business day of a month.

For example, by generating categories on each day of the week, the presence or absence of usage of each file for each day of the week is set in the file usage status list 115. Whether or not a file is used may be monitored by hooking an event concerning file usage.

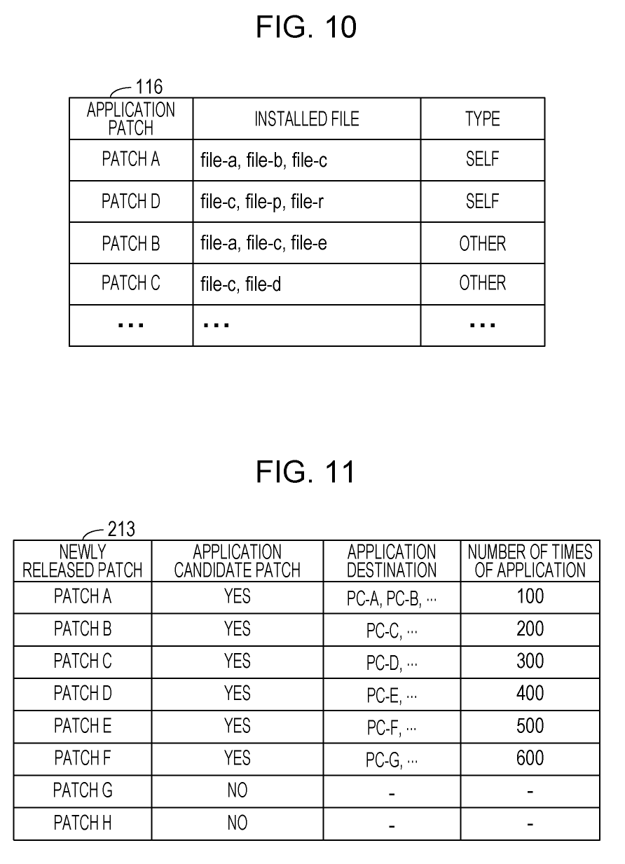

FIG. 10 is a table illustrating an example of a new-patch application result list. In the new-patch application result list 116, fields for an application patch, an installed file, and a type are provided.

In the field of the application patch, a name of a newly released patch (application patch) applied to any one of the plurality of terminal devices 100, 100a, . . . is set. In the field of the installed file, a name of a file installed by applying a newly released patch is set. In the field of the type, information indicating whether a terminal device to which the newly released patch is applied is the terminal device 100 itself (Self) or one of the other terminal devices 100a, . . . (Other) is set.

The matters described above are the details of information stored in the storing unit 110 of the terminal device 100. The software dictionary 211 and the patch configuration file list 212 stored in the storing unit 210 of the management server 200 are the same information as the software dictionary 111 and the patch configuration file list 112 stored in the storing unit 110 of the terminal device 100, respectively. The new-patch application result list 214 stored in the storing unit 210 of the management server 200 is a data table obtained by excluding information of the field of the type from the new-patch application result list 116 (see FIG. 10) stored in the storing unit 110 of the terminal device 100.

Hereinafter, among the information stored in the storing unit 210 of the management server 200, the newly-released-patch application management table 213 that is not stored in the storing unit 110 of the terminal device 100 will be described in detail with reference to FIG. 11.

FIG. 11 is a table illustrating an example of a newly-released-patch application management table. In the newly-released-patch application management table 213, fields for a newly released patch, an application candidate patch, an application destination, and the number of times of application are provided. In the field of the newly released patch, a name of the newly released patch is set. In the field of the application candidate patch, information indicating whether or not at least one of the plurality of terminal devices 100, 100a, . . . determines the newly released patch as the application candidate patch is set. For example, in a case where software to be corrected by the newly released patch is installed and the newly released patch is not yet applied to that software, each of the plurality of terminal devices 100, 100a, . . . determines the newly released patch as an application candidate patch. If there is a terminal device that determines the newly released patch as the candidate application patch, “YES” is set in the field of the application candidate patch, and if there is no terminal device that determines the newly released patch as the candidate application patch, “NO” is set in the field of the application candidate patch. In the field of the application destination, a name of a terminal device to which the newly released patch is to be applied is set. In the field of the number of times of application, the number of terminal devices to which the newly released patch is to be applied is set.

Efficient patch application is performed using information described above. Hereinafter, patch application processing will be described in detail.

Patch application processing is divided into two stages. In first stage patch application processing, an application patch is determined by a first application patch determination method and a second application patch determination method. Then, a determined application patch is applied. In second stage patch application processing, an additional application patch is determined by a third application patch determination method. Then, an additional application patch is applied.

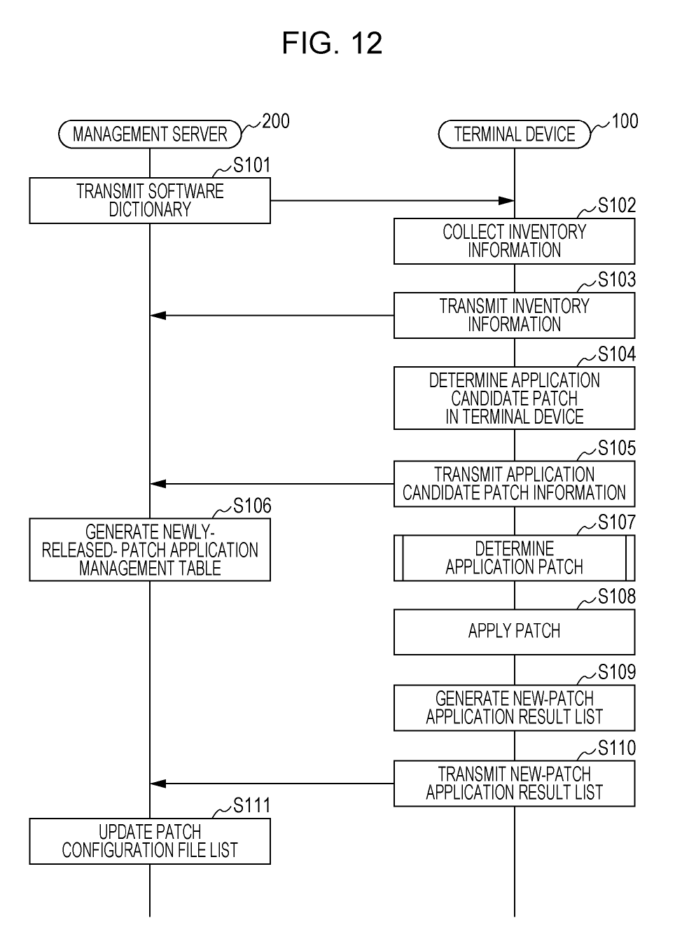

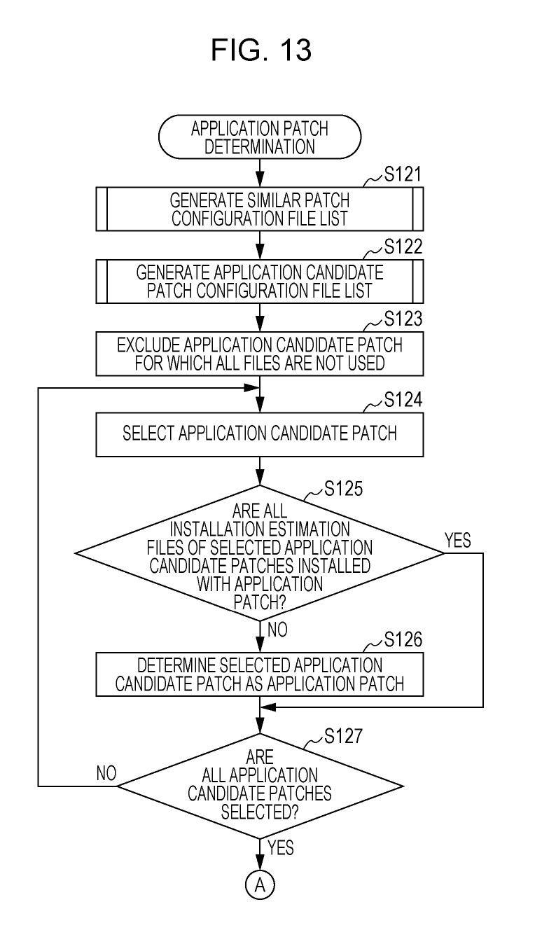

FIG. 12 is a sequence diagram illustrating a procedure of first stage patch application processing. Processing illustrated in FIG. 12 is started when a new public patch is stored in the management server 200, for example, by an administrator of a system. Hereinafter, processing illustrated in FIG. 12 will be described along step numbers.

[Step S101] The management server 200 transmits a software dictionary to the terminal device 100 together with a list of newly released patches. For example, the software dictionary acquisition unit 220 of the management server 200 acquires the software dictionary 311 (see FIG. 4) in the storing unit 310 from the software dictionary distribution server 300 and stores the software dictionary 311 in the storing unit 210 as the software dictionary 211 of the management server 200. The patch application management unit 230 acquires the software dictionary 211 from the storing unit 210 and transmits the software dictionary 211 to the terminal device 100 together with a list of new application target patches. In the terminal device 100, the patch information collection unit 120 receives the software dictionary 211, and stores the software dictionary 211 in the storing unit 110 as the software dictionary 111 in the terminal device 100.

[Step S102] The application patch selection unit 130 of the terminal device 100 collects inventory information in the terminal device 100. The inventory information is, for example, information on software installed in the terminal device 100.

[Step S103] The application patch selection unit 130 transmits the collected inventory information to the management server 200.

[Step S104] The application patch selection unit 130 determines an application candidate patch. For example, the application patch selection unit 130 selects an application candidate patch to the terminal device 100, based on the collected inventory information and information of the software dictionary 111. For example, the application patch selection unit 130 determines the presence or absence of inventory information that satisfies the determination logic of the definition type “audit” for each of the plurality of pieces of software definition information 111a, 111b, . . . in the software dictionary 111. In a case where the determination logic of the definition type “audit” of the software definition information is satisfied, the patch indicated in the field of the name of the definition type “audit” is determined as the application candidate patch. For example, in a case where the determination logic of the definition type “audit” of the software definition information 111a illustrated in FIG. 5 is satisfied, the application patch selection unit 130 determines that a “patch A” is an application candidate patch.

[Step S105] The application patch selection unit 130 transmits application candidate patch information indicating the application candidate patch to the management server 200.

[Step S106] The patch application management unit 230 of the management server 200 generates the newly-released-patch application management table 213. For example, the patch application management unit 230 registers a record corresponding to each of the newly released patches with the newly-released-patch application management table 213. An initial value in the field of the application candidate patch of each record is “NO”. Then, when application candidate patch information indicating that the newly released patch is the application candidate patch is received from any of the plurality of terminal devices 100, 100a, . . . the patch application management unit 230 sets “YES” in the field of the candidate application patch of the newly released patch. Furthermore, the patch application management unit 230 sets the name of the terminal device for which the newly released patch is determined as the application candidate patch, in the field of the application destination corresponding to the newly released patch, and adds 1 to the value in the field of the number of times of application.

[Step S107] The application patch selection unit 130 of the terminal device 100 executes determination processing of an application patch to be actually applied among the application candidate patches. Details of application patch determination processing will be described later (see FIG. 13).

[Step S108] The patch application unit 140 applies the newly released patch determined as the application patch. For example, in a case where the application patch is provided as a patch file of an executable format, the patch application unit 140 executes the patch file.

[Step S109] When application of the newly released patch determined as the application patch is completed, the patch application unit 140 generates the new-patch application result list 116. For example, the patch application unit 140 registers a record including the name of the applied newly released patch and the file name of the file installed at the time of application with the new-patch application result list 116. In this case, in the field of the type of record registered, a value of “Self” indicating that the newly released patch is applied to an own device is set.

[Step S110] The patch application unit 140 stores the new-patch application result list 116 in the storing unit 110 and transmits the new-patch application result list 116 to the management server 200.

[Step S111] The patch application management unit 230 of the management server 200 updates the patch configuration file list 112 based on the acquired new-patch application result list 116. For example, the patch application management unit 230 registers a record including a combination of the name of the newly released patch in the new-patch application result list 116 and the file name of the file installed at the time of application, with the patch configuration file list 112.

As such, the minimum patch determined based on information of the files installed during application of the patches applied in the past is applied.

Next, application patch determination processing will be described in detail.

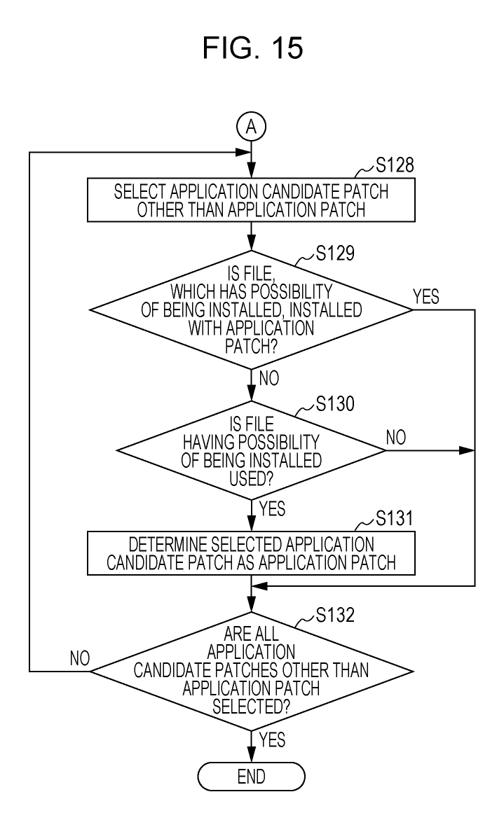

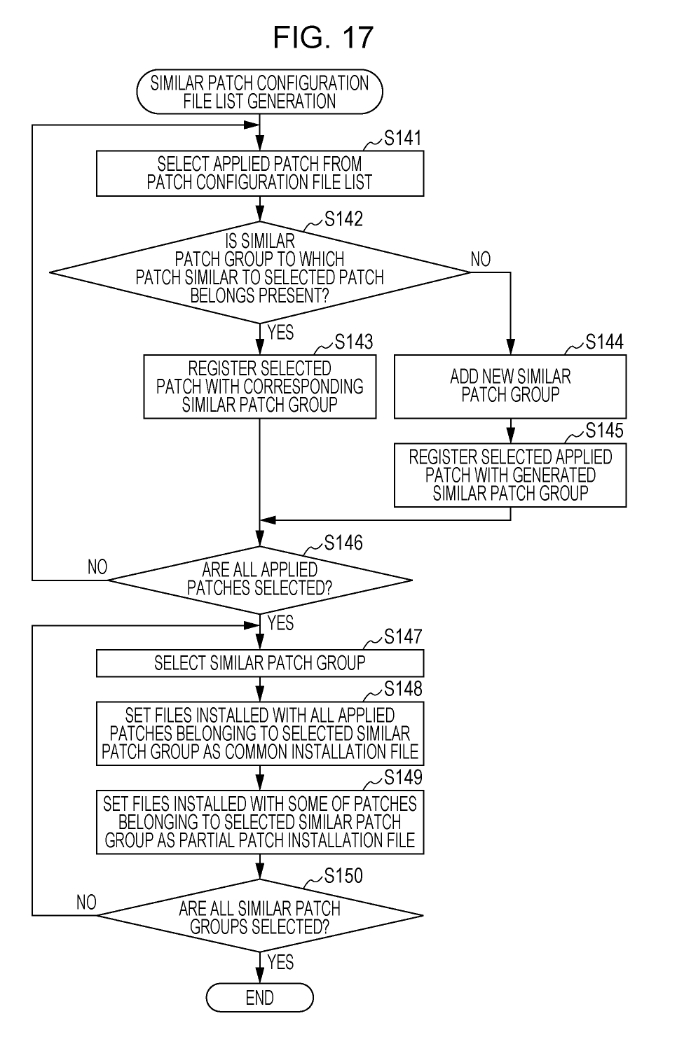

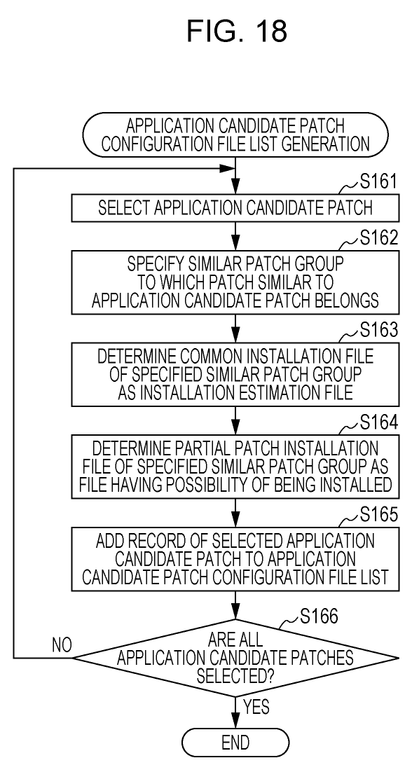

FIG. 13 is a first half of a flowchart illustrating an example of a procedure of application patch determination processing. Hereinafter, processing illustrated in FIG. 13 will be described along step numbers.

[Step S121] The application patch selection unit 130 generates a similar patch configuration file list 113 based on the software dictionary 111 and the patch configuration file list 112. Details of the processing will be described later (see FIG. 17).

[Step S122] The application patch selection unit 130 generates the application candidate patch configuration file list 114 based on the software dictionary 111 and the similar patch configuration file list 113. Details of the processing will be described later (see FIG. 18).

[Step S123] The application patch selection unit 130 excludes newly released patches for which all files are not used from the application target patches, based on the file usage status list 115.

[Step S124] The application patch selection unit 130 selects one application candidate patch that has not undergone processing of steps S125 to S126 among the application candidate patches in the terminal device 100.

[Step S125] The application patch selection unit 130 determines whether or not it is estimated that all installation estimation files of the selected application candidate patches are installed by applying the application candidate patches already determined as the application patches. For example, in a case where all installation estimation files of the selected application candidate patches are included in one of the installation estimation files already determined as the application patches, the application patch selection unit 130 determines the determination result in Step S125 is “YES”. In a case where it is estimated that all installation estimation files are installed at the time of application of the application patch, the application patch selection unit 130 allows processing to proceed to Step S127 without setting the selected application candidate patch as an application patch. In a case where it is not estimated that at least a portion of the installation estimation files of the selected application candidate patches is installed at the time of application of the application patch, the application patch selection unit 130 allows processing to proceed to Step S126.

[Step S126] The application patch selection unit 130 determines the application candidate patch selected in Step S124 as the application patch.

[Step S127] The application patch selection unit 130 determines whether all application candidate patches are selected in Step S124. When it is determined that an unselected application candidate patch is present, the application patch selection unit 130 allows processing to proceed to Step S124. When it is determined that all application candidate patches are selected, the application patch selection unit 130 allows processing to proceed to Step S128 (see FIG. 15).

As such, based on the installation estimation file, the application patch to be actually applied to the terminal device 100 is determined by the first application patch determination method.

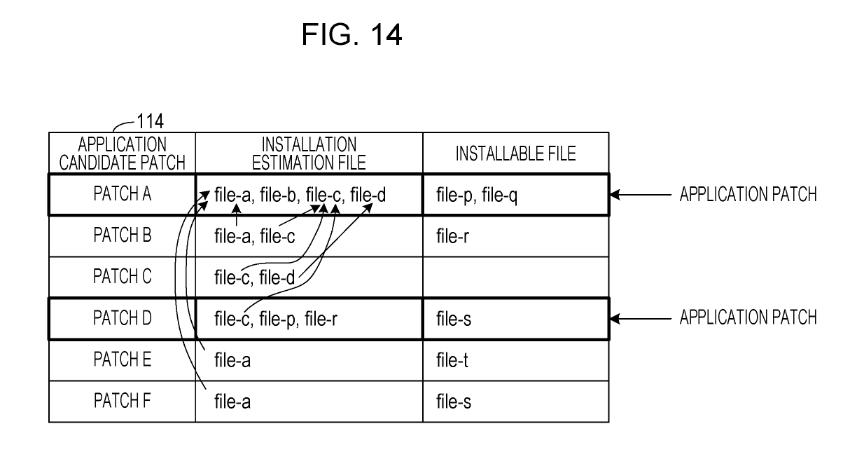

FIG. 14 is a diagram illustrating an example of determination of an application patch by a first application patch determination method. First, the application patch selection unit 130 selects the application candidate patch of “patch A” indicated in the first record of the application candidate patch configuration file list 114. At this stage, since there is no application patch, the application candidate patch of “patch A” is determined as an application patch.

Next, the application patch selection unit 130 selects the application candidate patch of “patch B” indicated in the second record of the application candidate patch configuration file list 114. All the installation estimation files of the application candidate patch of “patch B” are included in the installation estimation files of “patch A” determined as the application patch. That is, if the “patch A” is applied, it is estimated that files to be installed when the “patch B” is applied are also installed. Accordingly, the “patch B” is excluded from the application patches.

Next, the application patch selection unit 130 selects the application candidate patch of “patch C” indicated in the third record of the application candidate patch configuration file list 114. All the installation estimation files of the application candidate patch of “patch C” are included in the installation estimation files of “patch A” determined as the application patch. Accordingly, the “patch C” is excluded from application patches.

Next, the application patch selection unit 130 selects the application candidate patch of “patch D” indicated in the fourth record of the application candidate patch configuration file list 114. The “file-p” and “file-r” among the installation estimation files of the application candidate patch of “patch D” are not included in the installation estimation files of the “patch A” determined as the application patch. Accordingly, the “patch D” is determined as an application patch.

Next, the application patch selection unit 130 selects the application candidate patch of “patch E” indicated in the fifth record of the application candidate patch configuration file list 114. All the installation estimation files of the application candidate patch of “patch E” are included in the installation estimation file of the “patch A” determined as the application patch. Accordingly, the “patch E” is excluded from application patches.

Next, the application patch selection unit 130 selects the application candidate patch of “patch F” indicated in the sixth record of the application candidate patch configuration file list 114. All the installation estimation files of the application candidate patch of “patch F” are included in the installation estimation files of the “patch A” determined as the application patch. Accordingly, the “patch F” is excluded from the application patches.

By processing as described above, the “patch A” and “patch D” are determined as the application patches. In this case, a set of the installation estimation files of respective ones of the application candidate patches and a set of the installation estimation files of the “patch A” and “patch D” which are the application patches are equal. That is, all installation estimation files of the six application candidate patches may be installed by applying two application patches.

Thereafter, if a file having a possibility of being installed is used within a predetermined period for the application candidate patch which is not determined as the application patch, the application patch selection unit 130 also determines the application candidate patch as the application patch. For example, files whose installation has failed are determined based on the following criteria.

First, files having a possibility of being installed only with application candidate patches, which have already become the application patches, will not be determined to be files whose installation has failed (for example, “file-p” and “file-q” of “patch A”). Among the files having a possibility of being installed with the application candidate patches that are not the application patch, it is assumed that the files included in the installation estimation files of the application patch are installed (for example, “file-r” of patch B). Conversely, among files having a possibility of being installed with the application candidate patches that are not the application patch, files that are not included in the installation estimation files of the application patches are determined to be files whose installation has failed (for example, “file-t” of patch E and “file-s” of patch F).

With respect to a file determined as the file whose installation has failed, only in a case where it is determined that the file is being used in a category to which the current terminal device belongs, the application candidate patch including the file is determined as an application patch.

FIG. 15 is a second half of the flowchart illustrating the example of the procedure of application patch determination processing. Hereinafter, processing illustrated in FIG. 15 will be described along step numbers.

[Step S128] The application patch selection unit 130 selects one of the application candidate patches that are not undergone processing of steps S129 to S131 among the application candidate patches not determined as the application patches in Step S126.

[Step S129] The application patch selection unit 130 determines whether or not all files having a possibility of being installed at the time of application of the selected application candidate patch are installed by applying the application patch. For example, in a case where the file having a possibility of being installed at the time of application of the selected application candidate patch is included in the installation estimation files of the application patch, the application patch selection unit 130 determines that the file is installed. In a case where all corresponding application files are installed by applying the application patches, the application patch selection unit 130 allows processing to proceed to Step S132. In a case where some of the corresponding files may not be installed even if the application patch is applied, the application patch selection unit 130 allows processing to proceed to Step S130.

[Step S130] The application patch selection unit 130 determines whether or not the file having a possibility of being installed in the selected application candidate patch is used within the predetermined period (for example, within today) in the terminal device 100. For example, the application patch selection unit 130 refers to the application candidate patch configuration file list 114 and specifies a file having a possibility of being installed when the selected application candidate patch is applied. Next, the application patch selection unit 130 refers to the file usage status list and confirms a usage status of the specified file in the category that matches the current status of the terminal device 100. For example, if today is Monday, the application patch selection unit 130 confirms the usage status of the specified file in the category corresponding to Monday. In a case where it is indicated that the specified file in the corresponding category is used, the application patch selection unit 130 determines that the specified file is used within a predetermined period. In a case where the specified file is used within the predetermined period, the application patch selection unit 130 allows processing to proceed to Step S131. In a case where the specified file is not to be used within the predetermined period, the application patch selection unit 130 allows processing to proceed to Step S132.

[Step S131] The application patch selection unit 130 determines the application candidate patch selected in Step S128 as an application patch.

[Step S132] The application patch selection unit 130 determines whether or not all application candidate patches not determined as the application patches in Step S126 are selected in Step S128. When it is determined that an unselected corresponding application candidate patch is present, the application patch selection unit 130 allows processing to proceed to Step S128. When it is determined that all corresponding application candidate patches are selected, the application patch selection unit 130 ends application patch determination processing.

As such, in a case where the file having a possibility of being installed at the time of application of the application candidate patch is used soon, the application candidate patch is determined by the second application patch determination method.

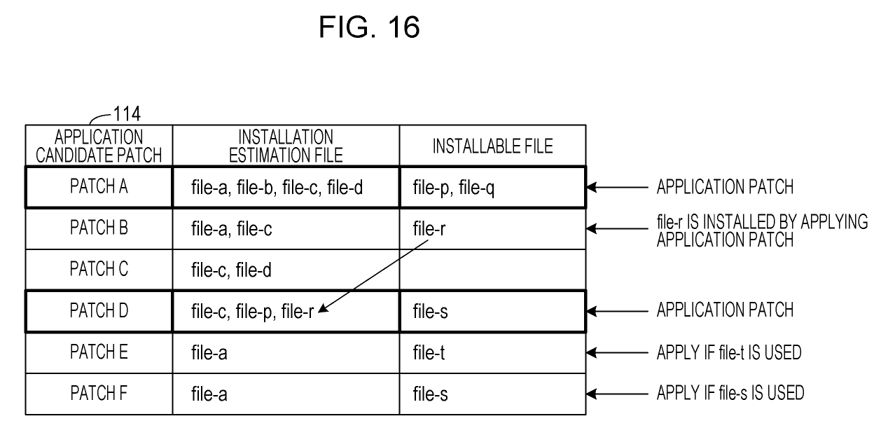

FIG. 16 a diagram illustrating an example of determination of an application patch by the second application patch determination method. First, the application patch selection unit 130 selects the application candidate patch of “patch B” indicated in the second record of the application candidate patch configuration file list 114, among the application target patches not determined as the application patch. The “file-r” having a possibility of being installed at the time of application of the application candidate patch of “patch B” is installed at the time of application of the “patch D” which is an application patch. Accordingly, the “patch B” is excluded from the application patches.

Next, the application patch selection unit 130 selects the application candidate patch of “patch C” indicated in the third record of the application candidate patch configuration file list 114. The application candidate patch of “patch C” has no file, other than the installation estimation files, having a possibility of being installed. For that reason, the “patch C” is excluded from the application patches.

Next, the application patch selection unit 130 selects the application candidate patch of “patch E” indicated in the fifth record of the application candidate patch configuration file list 114. The “file-t” having a possibility of being installed at the time of application of the application candidate patch of “patch E” is not included in the installation estimation files of the application patch. For that reason, if the “file-t” is used within a predetermined period, the “patch E” is determined as an application patch.

Next, the application patch selection unit 130 selects the application candidate patch of “patch F” indicated in the sixth record of the application candidate patch configuration file list 114. The “file-s” having a possibility of being installed at the time of application of the application candidate patch of “patch F” is not included in the installation estimation files of the application patch. For that reason, if the “file-s” is used within a predetermined period, the “patch F” is determined as an application patch.

As such, the application patch selection unit 130 determines whether or not to apply the application candidate patch, according to the usage status of the file having a possibility of being installed at the time of application of the application candidate patch. With this, for example, even if the patch is the application candidate patch, in a case where the installed file is not used immediately and urgency of application is low, the timing of applying patches may be delayed. As a result, even in a case where a large number of newly released patches are released at one time, only patches with high urgency may be quickly selected and applied, and a period during which the terminal device 100 may not be used due to patch application may be shortened.

Next, similar patch configuration file list generation processing (Step S121) will be described in detail.

FIG. 17 is a flowchart illustrating an example of a procedure of similar patch configuration file list generation processing. Hereinafter, processing illustrated in FIG. 17 will be described along step numbers.

[Step S141] The application patch selection unit 130 selects one applied patch from the patch configuration file list 112.

[Step S142] The application patch selection unit 130 determines whether or not a similar patch group, to which a patch similar to the selected applied patch belongs, is present in the similar patch configuration file list 113. For example, the application patch selection unit 130 determines, for each of the similar patch groups, whether both an application target product of the patch belonging to the similar patch group and a file (determination file) used for determining whether the patch is not applied or is applied are the same as those of the selected applied patch. If the application target product and the determination file are the same between the patch and the selected applied patch, the application patch selection unit 130 determines that the similar patch group is a similar patch group to which the patch similar to the selected applied patch belongs. The application target product and the determination file of each patch are indicated in the software definition information for determining whether or not the corresponding patch is applied.

In a case where it is determined that a corresponding similar patch group is present, the application patch selection unit 130 allows processing to proceed to Step S143. In a case where it is determined that the application patch group is not present, the application patch selection unit 130 allows processing to proceed to Step S144.

[Step S143] The application patch selection unit 130 registers the name of the selected applied patch, with the field of the patch of the record of the similar patch group, to which the patch similar to the selected applied patch belongs, in the similar patch configuration file list 113. Thereafter, the application patch selection unit 130 allows processing to proceed to Step S146.

[Step S144] The application patch selection unit 130 adds a new record of the similar patch group to the similar patch configuration file list 113.

[Step S145] The application patch selection unit 130 registers the name of the selected applied patch with the field of the patch of the new record of the similar patch group added in the similar patch configuration file list 113.

[Step S146] The application patch selection unit 130 determines whether or not all application patches are selected. When it is determined that an unselected applied patch is present, the application patch selection unit 130 allows processing to proceed to Step S141. When it is determined that all application patches are already selected, the application patch selection unit 130 allows processing to proceed to Step S147.

[Step S147] The application patch selection unit 130 selects one similar patch group from the similar patch configuration file list 113.

[Step S148] The application patch selection unit 130 sets the files installed with all the applied patches belonging to the selected similar patch group as the common installation file. For example, the application patch selection unit 130 refers to the similar patch configuration file list 113 and specifies one or more applied patches belonging to the selected similar patch group. Next, the application patch selection unit 130 refers to the patch configuration file list 112 and specifies the file installed when each of the specified application patches is applied. Next, the application patch selection unit 130 sets the name of the file installed at the time of application for all the specified applied patches, in the field of the common installation file of the selected similar patch group.

[Step S149] The application patch selection unit 130 sets the files installed with some of the applied patches belonging to the selected similar patch group as the partial patch installation file. For example, the application patch selection unit 130 refers to the similar patch configuration file list 113 and specifies one or more applied patches belonging to the selected similar patch group. Next, the application patch selection unit 130 refers to the patch configuration file list 112 and specifies the file installed when each of the specified application patches is applied. Next, the application patch selection unit 130 sets the name of the file installed at the time of application in some of the identified application patches in the field of the partial patch installation file of the selected similar patch group.

[Step S150] The application patch selection unit 130 determines whether or not all similar patch groups are selected. When it is determined that an unselected similar patch group is present, the application patch selection unit 130 allows processing to proceed to Step S147. When it is determined that all similar patch groups are selected, the application patch selection unit 130 ends generation processing of the similar patch configuration file list 113.

As such, the similar patch configuration file list 113 is generated. Based on the generated similar patch configuration file list 113, the application candidate patch configuration file list 114 may be created.

FIG. 18 is a flowchart illustrating an example of a procedure of application candidate patch configuration file list generation processing. Hereinafter, processing illustrated in FIG. 18 will be described along step numbers.

[Step S161] The application patch selection unit 130 selects one of the application candidate patches. The application candidate patches are determined from the newly released patches in processing of Step S104 illustrated in FIG. 12.

[Step S162] The application patch selection unit 130 specifies the similar patch group, to which the patch similar to the selected application candidate patch belongs, from the similar patch configuration file list 113.

[Step S163] The application patch selection unit 130 determines the common installation file of the specified similar patch group as the installation estimation file of the selected application candidate patch.

[Step S164] The application patch selection unit 130 determines the partial patch installation file of the specified similar patch group as the file having a possibility of being installed of the selected application candidate patch.

[Step S165] The application patch selection unit 130 adds the record of the selected application candidate patch to the application candidate patch configuration file list 114. In the field of the installation estimation file of the added record, the file name of the installation estimation file determined in Step S163 is set. In the field of the file having a possibility of being installed of the added record, the file name of the file having a possibility of being installed determined in Step S164 is set.

[Step S166] The application patch selection unit 130 determines whether or not all application candidate patches are selected. In a case where it is determined that an unselected application candidate patch is present, the application patch selection unit 130 allows processing to proceed to Step S161. When it is determined that all application candidate patches are selected, the application patch selection unit 130 ends application candidate patch configuration file list generation processing.

By processing illustrated in FIG. 12 to FIG. 18, the first stage patch application processing is performed. In the first stage patch application processing, files to be installed at the time of application of the application candidate patch are estimated from the files installed in the applied patches similar to the application candidate patches. However, when the application candidate patch is actually applied, the estimated file may not be installed. In a case where it turns out that the files that were estimated to be installed but not installed are installed with application of an unapplied application candidate patch, the unapplied application candidate patch is additionally applied by second stage patch application processing.

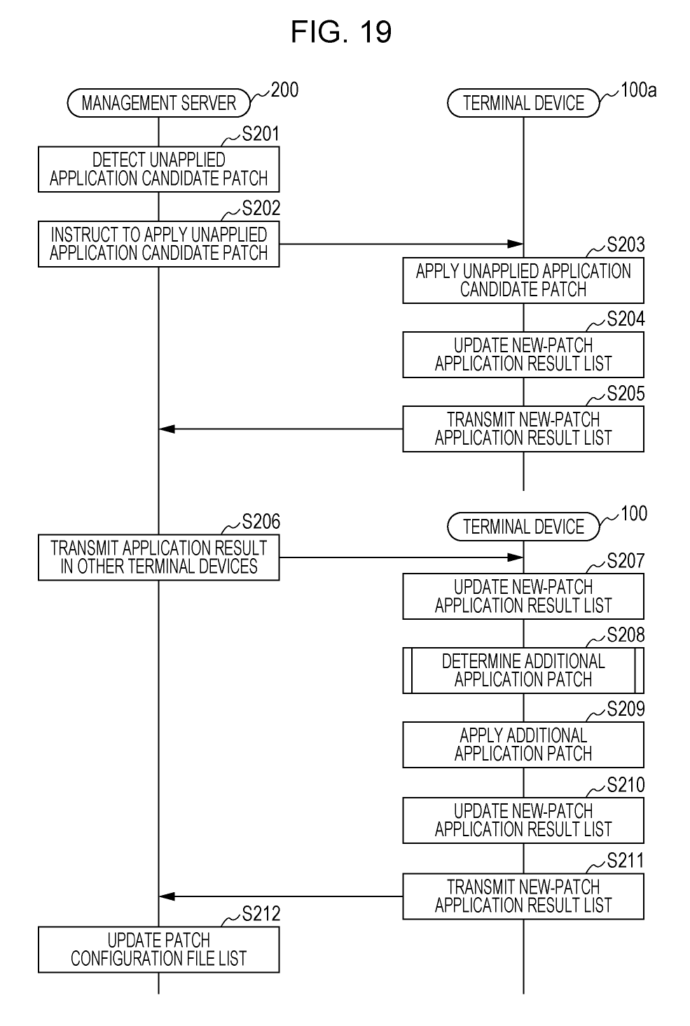

FIG. 19 is a sequence diagram illustrating a procedure of second stage patch application processing. Hereinafter, processing illustrated in FIG. 19 will be described along step numbers.

[Step S201] The patch application management unit 230 of the management server 200 detects the unapplied application candidate patch. For example, the patch application management unit 230 recognizes application candidate patch applied in each of the plurality of terminal devices 100, 100a, . . . , based on the new-patch application result lists received from all the plurality of terminal devices 100, 100a, . . . . Further, the patch application management unit 230 refers to the newly-released-patch application management table 213 and determines the application candidate patch among the newly released patches. Then, the patch application management unit 230 detects the application candidate patch not included in any of the new-patch application result lists received from the plurality of terminal devices 100, 100a, . . . as the unapplied application candidate patch.

[Step S202] The patch application management unit 230 refers to the newly-released-patch application management table 213, selects one of the terminal devices which become the application destination of the unapplied application candidate patch, and notifies the terminal device to apply the unapplied application candidate patch. In the example of FIG. 19, it is assumed that an instruction to apply is transmitted to the terminal device 100a.

[Step S203] The terminal device 100a applies the unapplied application candidate patch in accordance with the instruction to apply the unapplied application candidate patch from the management server 200. In this case, the terminal device 100a detects a file update event output by a process of applying the application candidate patch, and recognizes the installed file.

[Step S204] The terminal device 100a updates its own new-patch application result list. For example, the terminal device 100a adds a record corresponding to the application candidate patch applied in Step S203 to the new-patch application result list. In the field of the installed file of the added record, the file name of the file installed at the time of applying the application candidate patch at Step S203 is set. Further, in the field of the type of the added record, the “Self” is set.

[Step S205] The terminal device 100a transmits the updated new-patch application result list to the management server 200.

[Step S206] The patch application management unit 230 of the management server 200 transmits the application result of the application candidate patch in the other terminal devices to each of the plurality of terminal devices 100, 100a, . . . . The application result to be transmitted includes the name of the applied application candidate patch and the name of the file installed at the time of application.

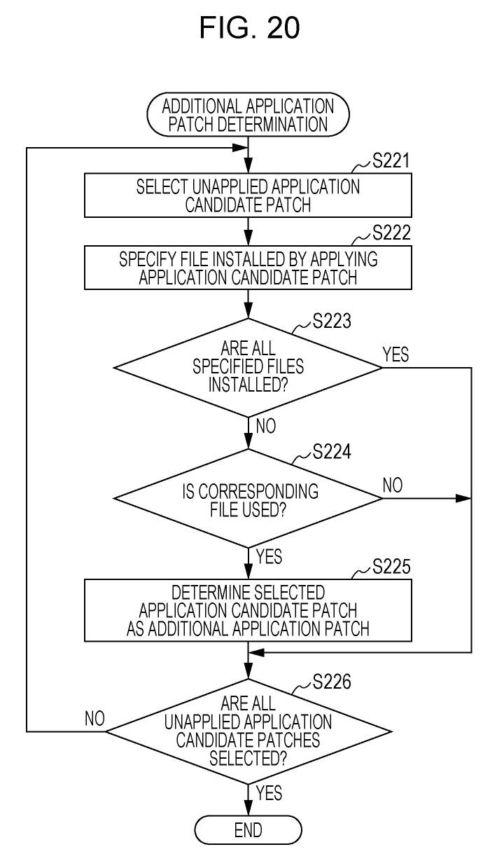

Each of the plurality of terminal devices 100, 100a, . . . which receives the application result of the application candidate patch in the other terminal devices 100a, . . . performs second stage patch application processing. Hereinafter, processing in Step S207 and subsequent steps illustrated in FIG. 19 will be described by taking the second stage patch application processing in the terminal device 100 as an example.

[Step S207] When the application result of the application candidate patch in the other terminal devices 100a, . . . is received from the management server 200, the patch information collection unit 120 of the terminal device 100 updates the new-patch application result list 116. For example, the patch application unit 140 adds a record corresponding to the application candidate patch applied by the other terminal devices 100a, . . . to the new-patch application result list 116. In the field of the installed file of the added record, the file name of the file installed at the time of applying the application candidate patch is set. In the field of the type of the added record, “Other” is set.

[Step S208] The application patch selection unit 130 determines an additional application patch to be newly applied among the unapplied application candidate patches. Details of additional application patch determination processing will be described later (see FIG. 20).

[Step S209] The patch application unit 140 applies the additional application patch.

[Step S210] The patch application unit 140 updates the new-patch application result list 116. For example, the patch application unit 140 adds the record corresponding to the additional application patch applied in Step S209 to the new-patch application result list 116. In the field of the installed file of the added record, the file name of the file installed at the time of applying the additional application patch at Step S209 is set. Further, in the field of the type of the added record, “Self” is set.

[Step S211] The patch application unit 140 transmits the updated new-patch application result list 116 to the management server 200.

[Step S212] The patch application management unit 230 of the management server 200 updates the patch configuration file list. For example, the patch application management unit 230 updates the patch configuration file list 112 based on the new-patch application result list received in Steps S205 and S211.

Next, additional application patch determination processing will be described in detail.

FIG. 20 is a flowchart illustrating an example of a procedure of additional application patch determination processing. Hereinafter, processing illustrated in FIG. 20 will be described along step numbers.

[Step S221] The application patch selection unit 130 selects one unapplied application candidate patch. For example, the application patch selection unit 130 determines the patch, which is registered as the type of “Other” in the new-patch application result list 116, among the application candidate patches indicated in the application candidate patch configuration file list 114, as the unapplied application candidate patch.

[Step S222] The application patch selection unit 130 specifies the file installed by applying the selected application candidate patch. For example, the application patch selection unit 130 refers to the new-patch application result list 116, and specifies the file registered in association with the name of the selected application candidate patch as the file to be installed by applying the application candidate patch.

[Step S223] The application patch selection unit 130 determines whether or not all specified files are installed with the patches already applied to the terminal device 100 itself. For example, in a case where the application patch selection unit 130 refers to the new-patch application result list 116 and the file specified in Step S222 is registered with the field of the installed file in the record of the type of “Self”, the application patch selection unit 130 determines that the file is installed. Also, in a case where the application patch selection unit 130 refers to the new-patch application result list 116 and the file identified in Step S222 is not registered with the field of the installed file in the record of the type of “Self”, the application patch selection unit 130 determines that the file is not installed.

In a case where at least one of the specified files is not installed, the application patch selection unit 130 allows processing to proceed to Step S224. In a case where all the specified files are installed, the application patch selection unit 130 allows processing to proceed to Step S226.

[Step S224] The application patch selection unit 130 determines whether or not to use a file (uninstalled file) that is not installed among the files specified in Step S222 within a predetermined period. For example, the application patch selection unit 130 refers to the file usage status list 115 and confirms whether or not the uninstalled file in the current category in the terminal device 100 is used. In a case where it is indicated that the uninstalled file is used, the application patch selection unit 130 determines to use the uninstalled file within a predetermined period.

In a case where it is determined that the uninstalled file is used within the predetermined period, the application patch selection unit 130 allows processing to proceed to Step S225. In a case where it is determined that the uninstalled file is not used within the predetermined period, the application patch selection unit 130 allows processing to proceed to Step S226.

[Step S225] The application patch selection unit 130 determines the selected application candidate patch as the additional application patch.

[Step S226] The application patch selection unit 130 determines whether or not all unapplied application candidate patches are selected. When it is determined that an unselected application candidate patch which is not applied is present among the unapplied application candidate patches, the application patch selection unit 130 allows processing to proceed to step S221. When it is determined that all unapplied application candidate patches are already selected, the application patch selection unit 130 ends additional application patch determination processing.

By doing as described above, the additional application patch is determined. With this, as a result of actually applying the application candidate patch of an own terminal device by another terminal device, in a case where it is determined that the file to be installed with the application candidate patch of the own terminal device is not yet installed in the own terminal device, the application candidate patch is also applied to the own terminal device. As a result, it is possible to avoid omission of installation of the file to be installed with the application candidate patch.

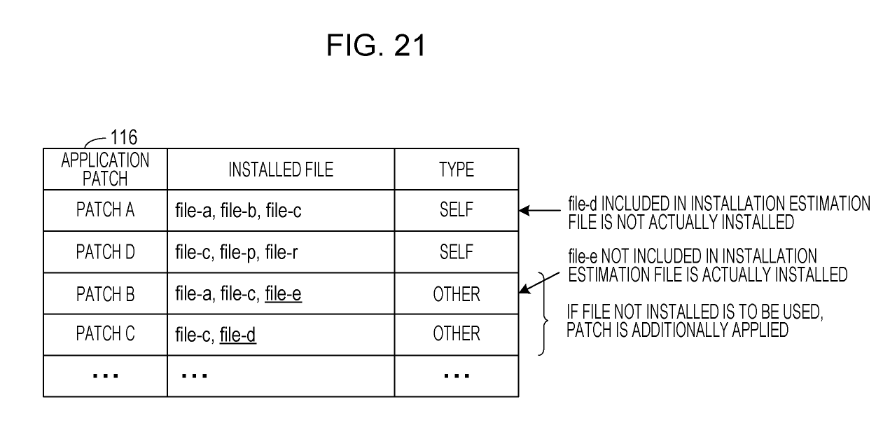

FIG. 21 is a diagram illustrating an example of determination of an additional application patch. For example, the application patch selection unit 130 of the terminal device 100 determines the “patch A” and “patch D” as the application patches by the first stage patch application processing. In this case, the “patch A” and “patch D” are applied to the terminal device 100 and information on the installed files is acquired. Information on the installed files is registered with the new-patch application result list 116. Other patches (for example, “patch B” and “patch C”) are applied to any of the other terminal devices 100a, . . . and the application result is reflected in the new-patch application result list 116 of the terminal device 100.

In the example of FIG. 21, the “file-a, file-b, and file-c” are installed by applying the “patch A”. It is estimated, in the application candidate patch configuration file list 114 (see FIG. 8), that the “file-a, file-b, file-c, and file-d” will be installed at the time of application of the “patch A”. That is, the “file-d” estimated to be installed at the time of application of the “patch A” is not actually installed. Regarding the “patch C”, it turns out that the “file-c and file-d” were installed at the time of application of the “patch C”, as a result of being applied by other terminal devices. The “patch C” is an application candidate patch of the terminal device 100 and thus, if the “file-d” is to be used within a predetermined period, the application patch selection unit 130 determines to additionally apply the “patch C”.

Regarding the “patch B”, it was turned out that the “file-a, file-c, and file-e” were installed at the time of application of the “patch B”, as a result of being applied by other terminal devices. In the application candidate patch configuration file list 114 (see FIG. 8), it is estimated that the “file-a and file-c” are installed at the time of application of the “patch B”. That is, the “file-e” which is not estimated to be installed at the time of application of the “patch B” is actually installed. Moreover, the “file-e” is not installed at the time of application of any of the “patch A” and “patch D” applied to the terminal device 100. The “patch B” is an application candidate patch of the terminal device 100 and thus, if the “file-e” is used within a predetermined period, the application patch selection unit 130 determines to additionally apply the “patch B”.

As a result, omission of installation of files to be used within a predetermined period may be suppressed while reducing the number of patches to be actually applied. As a result, it is possible to shorten a usage stop period of the terminal device 100 by patch application without leaving vulnerability of the terminal device 100.

The application time of the patch is shortened so as to make it possible to apply the patch without hindering work before starting work. As a result, it is possible to perform work using a terminal device that deals with vulnerability.

The software definition information 111a, 111b, . . . included in the software dictionary 111 are provided from, for example, a developer of software. Since the developer of software ascertains which file is installed by the patch, it is also conceivable to include information of the file to be installed in the software definition information 111a, 111b, . . . . However, when it is attempted to hold configuration file information of all patches by the software dictionary 111, the software dictionary 111 is enlarged. That is, since the software dictionary 111 is universally created so as to be usable by all enterprises, the enlargement of the software dictionary 111 is accelerated for the following reasons.

The software dictionary 111 has to cope with software patches used in all enterprises and may not easily delete information on past security patches. For that reason, if the capacity of each of the software definition information 111a, 111b, . . . becomes large, the software dictionary 111 is enlarged year by year. With such enlargement of the software dictionary 111, problems such as an increase in the number of man-hours of software dictionary creation and management, an increase in resources (disk, memory, network, and the like) to be used, and the like occur. As the enlargement of the software dictionary 111 progresses, it becomes difficult to estimate the resources (disk, memory, network, and the like) used for application of the patch. Then, finally, even if the software dictionary 111 corresponding to the newly released security patch is released, there is a concern that a problem of resource shortage occurs and the newly released patch may be applied.

Since such problems exist, it is difficult to allow the software dictionary 111 to deal with ascertaining of the files to be installed by application of the patch. According to the second embodiment, the file to be installed by applying the patch is estimated without enlarging the software dictionary 111 so as to make it possible to apply only a minimum number of patches. Moreover, since variation of the size of the software dictionary 111 is suppressed, system design becomes simpler and the system may be stably operated.

Also, it is also conceivable to apply first all patches released to an internal system and confirm the configuration file of all the patches beforehand in the enterprise, without using the software dictionary 111. In this case, the following problem occurs.

In a case of confirming the configuration file by using a dedicated test environment before applying the patch, a large-scale test environment is to be maintained and managed and it takes a lot of labor. Also, in a case of confirming the configuration file at the time of application of the patch by using an environment of a computer being operated, application of patches to other systems may not be performed until all patch configuration files may be confirmed, and patch application is delayed. Then, it is unable to achieve the purpose of quickly applying important patches like security patches. Moreover, since the configuration files of all the patches are to be confirmed, the confirmation time is not shorter than the application time of the patch having the longest application time. Furthermore, at the stage of confirming the configuration file of the released patch, the patch is also applied to software that is not used by any of the terminal devices and wasted time occurs.

As such, even if it is attempted to ascertain the configuration file of the patch by a method different from that of the second embodiment, it is unable to promptly apply a patch which is to be applied immediately.

### Other Embodiments

In the second embodiment, although generation processing of the similar patch configuration file list 113 is performed by each of the plurality of terminal devices 100, 100a, . . . , the generation processing may be performed by the management server 200. In this case, the generated similar patch configuration file list 113 is transmitted from the management server 200 to each of the plurality of terminal devices 100, 100a, . . . .

In the second embodiment, although generation processing of the application candidate patch configuration file list 114 is performed by each of the plurality of terminal devices 100, 100a, . . . , the generation processing may be performed by the management server 200. In this case, based on inventory information acquired from each of the plurality of terminal devices 100, 100a, . . . , the management server 200 generates the application candidate patch configuration file list 114 of each of the plurality of terminal devices 100, 100a, . . . . Then, the generated application candidate patch configuration file list 114 is transmitted from the management server 200 to each of the plurality of terminal devices 100, 100a, . . . .

Furthermore, in the additional application patch determination processing (see FIG. 20), when a file to be installed is not yet installed by applying an unapplied application candidate patch, the application candidate patch may be additionally applied regardless of the usage state of the file.

As described above, although the embodiments are exemplified, the configuration of each unit described in the embodiments may be replaced with another one having the same function. Also, any other components or processing steps may be added. Furthermore, any two or more configurations (characteristics) of the embodiments described above may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
acquiring first software-identification information identifying respective ones of first pieces of software that are candidates for installation;
estimating first files to be installed at a first time at which the first pieces of software are expected to be installed, with reference to a memory storing file-identification information identifying second files that have been installed at a second time at which second pieces of software have been installed, wherein the first file-identification information is stored in association with second software-identification information identifying respective ones of the second pieces of software, and the first files are estimated based on the file-identification information identifying third files among the second files, the third files being installed in connection with third pieces of software related to the first pieces of software among the second pieces of software;
identifying, from among the first pieces of software, one or more fourth pieces of software which include the estimated first files and which have less overlapping of installation of an identical file than a case of installing all the first pieces of software; and
executing installation of the one or more fourth pieces of software.

2. The non-transitory, computer-readable recording medium of claim 1, wherein:
the memory stores software definition information indicating characteristics of the first pieces of software and the second pieces of software; and
in the estimating, the software definition information is referred to, and one or more pieces of software having characteristics similar to those of the first pieces of software, among the second pieces of software, are determined as the third pieces of software related to the first pieces of software.

3. The non-transitory, computer-readable recording medium of claim 2, wherein:
in the software definition information, for each piece of the first pieces of software and the second pieces of software, a corresponding software product name and a file name used for determining necessity of installation are set; and
in the estimating, one or more pieces of software whose software product name and file name used for determining necessity of installation are common to those of the first pieces of software, among the second pieces of software, are determined as the third pieces of software related to the first pieces of software.

4. The non-transitory, computer-readable recording medium of claim 1, wherein:
in the estimating, when there exist plural pieces of software related to the first pieces of software, a common installation file that is a file commonly installed in respective ones of the plural pieces of software is estimated as one of the first files to be installed at the first time of installation of the first pieces of software.

5. The non-transitory, computer-readable recording medium of claim 1, wherein:
the memory stores a plurality of files and file-usage information indicating presence or absence of usage of the plurality of files within a corresponding operation period for each category relating to an operation period of the computer; the process further comprises referring to the memory and determining, for each of the first pieces of software, third files having a possibility of being installed at the first time of installation of the first pieces of software, based on the file-identification information identifying files that have been installed, in connection with the third pieces of software related to the first pieces of software, at the second time of installation of the second pieces of software; and
in the identifying, the file-usage information is referred to, and software for which the third files are used within the operation period corresponding to the category in accordance with a current date and time is identified as one of the one or more third pieces of software.

6. The non-transitory, computer-readable recording medium of claim 1, the process further comprising:
after installation of the one or more fourth pieces of software, acquiring the file-identification information identifying fourth files that have been installed at the first time of installation of the first pieces of software, based on actual installation results of the first pieces of software;
when there exists, among the fourth files, an uninstalled file that has not been installed at a time of installation of the one or more fourth pieces of software, identifying a piece of software that installs the uninstalled file at a time of installation of the piece of software, among the first pieces of software, as an additional installation target software; and
executing installation of the additional installation target software.

7. A method comprising:
acquiring first software-identification information identifying respective ones of first pieces of software that are candidates for installation;
estimating first files to be installed at a first time at which the first pieces of software are expected to be installed, with reference to a memory storing file-identification information identifying second files that have been installed at a second time at which second pieces of software have been installed, wherein the first file-identification information is stored in association with second software-identification information identifying respective ones of the second pieces of software, and the first files are estimated based on the file-identification information identifying third files among the second files, the third files being installed in connection with third pieces of software related to the first pieces of software among the second pieces of software;
identifying, from among the first pieces of software, one or more fourth pieces of software which include the estimated first files and which have less overlapping of installation of an identical file than a case of installing all the first pieces of software; and
executing installation of the one or more fourth pieces of software.

8. An apparatus comprising:
a memory; and
a processor coupled to the memory and configured to:
acquire first software-identification information identifying respective ones of first pieces of software that are candidates for installation,
estimate first files to be installed at a first time at which the first pieces of software are expected to be installed, with reference to a memory storing file-identification information identifying second files that have been installed at a second time at which second pieces of software have been installed, wherein the first file-identification information is stored in association with second software-identification information identifying respective ones of the second pieces of software, and the first files are estimated based on the file-identification information identifying third files among the second files, the third files being installed in connection with third pieces of software related to the first pieces of software among the second pieces of software,
identify, from among the first pieces of software, one or more fourth pieces of software which include the estimated first files and which have less overlapping of installation of an identical file than a case of installing all the first pieces of software, and
execute installation of the one or more fourth pieces of software.
